(19) United States
(12) Patent Application Publication
(10) Pub. No.: US 2025/0383918 A1
(43) Pub. Date: Dec. 18, 2025

(54) EFFICIENT SCALING OF ARTIFICIAL INTELLIGENCE MODELS

(71) Applicant: The Toronto-Dominion Bank, Toronto (CA)

(72) Inventors: Jesse Cole Cresswell, Toronto (CA); Maksims Volkovs, Toronto (CA); Taewoo Kim, Toronto (CA)

(73) Assignee: The Toronto-Dominion Bank, Toronto (CA)

(21) Appl. No.: 18/934,321

(22) Filed: Nov. 1, 2024

Related U.S. Application Data
(60) Provisional application No. 63/659,884, filed on Jun. 14, 2024.

(51) Int. Cl. G06F 9/50; G06N 20/20

(52) U.S. Cl. CPC G06F 9/5016; G06F 9/5027; G06N 20/20

(57) ABSTRACT

An example operation includes at least one of loading an Artificial Intelligence (AI) model from a storage, receiving input data for the AI model, creating a multi-output Gradient Boosted Tree (GBT) based on the input data, creating a decision tree with a split objective guided by at least one output of the multi-output GBT, creating a Scalable AI (SAI) model comprising the AI model, the decision tree, and the multi-output GBT, reducing memory use of the SAI by at least one of: deallocating memory held by the SAI when no longer used, loading input data in shared memory for sharing between worker-processes of the AI model, or storing arrays in memory as memory mapped files, and reducing processor cycles use of the SAI by performing computations by at least one of: using 32-bit floating-point resolution, using 64-bit floating-point resolution, using a same floating-point resolution for all calculations, or using vector floating-point operations on at least one of Graphical Processing Units (GPUs), Tensor Processing Units (TPUs), Neural Processing Units (NPUs), Artificial Intelligence Processors (AIPs), or Central Processing Units (CPUs).

### BACKGROUND

Tabular data generation is often developed on small datasets which do not match the scale of many scientific applications. Gradient-Boosted Trees, including XGBoost, perform well on tabular datasets but do not scale well to larger datasets for generative modeling. Therefore, there is a demand for an innovative solution that can efficiently scale generative modeling on small and large tabular datasets. Such a solution may significantly reduce the computational burden and cost associated with data preparation, enabling more rapid and effective training of machine learning models, and ultimately enhancing the performance and scalability of artificial intelligence (AI)-driven systems.

### SUMMARY

One example embodiment provides an apparatus that includes a memory and at least one processor, wherein the at least one processor and the memory are communicatively coupled, the at least one processor configured to perform at least one of receive input data for the AI model, create a multi-output Gradient Boosted Tree (GBT) based on the input data, create a decision tree with a split objective guided by at least one output of the multi-output GBT, implement a Scalable AI (SAI) model comprising the AI model, the decision tree, and the multi-output GBT, reduce memory use of the SAI by at least one of: the memory, held by the SAI, being deallocated when no longer used, the input data being loaded in shared memory to share between worker-processes of the SAI, and arrays, in the memory, being stored as memory mapped files, and reduce processor cycles use of the SAI, by the at least one processor, by at least one of: computations being performed in 32-bit floating-point resolution, computations being performed in 64-bit floating-point resolution, computations being performed in a same floating-point resolution for all calculations, or computations being performed as vector floating-point operations on at least one of Graphical Processing Units (GPUs), Tensor Processing Units (TPUs), Neural Processing Units (NPUs), Artificial Intelligence Processors (AIPs), or Central Processing Units (CPUs).

Another example embodiment provides a method that includes at least one of loading an Artificial Intelligence (AI) model from a storage, receiving input data for the AI model, creating a multi-output Gradient Boosted Tree (GBT) based on the input data, creating a decision tree with a split objective guided by at least one output of the multi-output GBT, creating a Scalable AI (SAI) model comprising the AI model, the decision tree, and the multi-output GBT, reducing memory use of the SAI by at least one of: deallocating memory held by the SAI when no longer used, loading input data in shared memory for sharing between worker-processes of the AI model, or storing arrays in memory as memory mapped files, and reducing processor cycles use of the SAI by performing computations by at least one of: using 32-bit floating-point resolution, using 64-bit floating-point resolution, using a same floating-point resolution for all calculations, or using vector floating-point operations on at least one of Graphical Processing Units (GPUs), Tensor Processing Units (TPUs), Neural Processing Units (NPUs), Artificial Intelligence Processors (AIPs), or Central Processing Units (CPUs).

A further example embodiment provides a non-transitory computer-readable storage medium comprising instructions, that when read by a processor, cause the processor to perform at least one of loading an Artificial Intelligence (AI) model from a storage, receiving input data for the AI model, creating a multi-output Gradient Boosted Tree (GBT) based on the input data, creating a decision tree with a split objective guided by at least one output of the multi-output GBT, creating a Scalable AI (SAI) model comprising the AI model, the decision tree, and the multi-output GBT, reducing memory use of the SAI by at least one of: deallocating memory held by the SAI when no longer used, loading input data in shared memory for sharing between worker-processes of the AI model, or storing arrays in memory as memory mapped files, and reducing processor cycles use of the SAI by performing computations by at least one of: using 32-bit floating-point resolution, using 64-bit floating-point resolution, using a same floating-point resolution for all calculations, or using vector floating-point operations on at least one of Graphical Processing Units (GPUs), Tensor Processing Units (TPUs), Neural Processing Units (NPUs), Artificial Intelligence Processors (AIPs), or Central Processing Units (CPUs).

### BRIEF DESCRIPTION OF DRAWINGS

FIG. 1 is a system diagram illustrating an operating environment of a software service according to examples and features of the instant solution.

FIG. 2A is a system diagram illustrating integration of an AI model into a classifier process according to the examples and features of the instant solution.

FIG. 2B is a diagram illustrating a process for developing an AI model that supports AI-assisted Efficient Scaling of AI Models according to the examples and features of the instant solution.

FIG. 2C is a diagram illustrating a process for utilizing an AI model that supports Efficient Scaling of AI Models according to examples and features of the instant solution.

FIG. 3 is a system diagram illustrating an operating environment for a product application service that provides Efficient Scaling of AI Models according to examples and features of the instant solution.

FIG. 4A is a diagram illustrating a method of Efficient Scaling of AI Models according to examples and features of the instant solution.

FIG. 4B is another diagram illustrating a method of Efficient Scaling of AI Models, according to examples and features of the instant solution.

FIG. 5 is a system diagram illustrating a computing environment according to the instant solution's example features, structures, or characteristics.

### DETAILED DESCRIPTION

The instant solution pertains to generative modelling on tabular data and specifically to generative modelling with Gradient-Boosted Trees on larger tabular datasets. The instant solution refines XGBoost (eXtreme Gradient Boosting), a Gradient-Boosted Tree framework, and uses the refined XGBoost as a function approximator on diffusion and flow-matching models on tabular data. The instant solution is configured to execute on computer systems, hosted compute infrastructure, Central Processing Units (CPU), Graphics Processing Units (GPU), Neural Processing Units (NPU), Tensor Processing Units (TPU), Artificial Intelligence (AI) Processor (AIP), other processing units, embedded computer systems, computer networks, wired and wireless compute devices, physical or virtual compute nodes. The instant solution additionally relates to systems and procedures, i.e. programming and configuration, for said generative modelling using Gradient-Boosted Trees.

The disclosure of the instant solution is expressed using terminology and concepts from Machine Learning (ML), artificial intelligence (AI), mathematics, statistics, and computer engineering. Examples include, but are not limited to, Large Language Model (LLM), Natural Language Processing (NLP), transformer, attention, In-Context Learning (ICL), k-Nearest Neighbor (kNN), k-means, gradient boosting, XGBoost, Area Under the receiver operating Characteristic Curve (AUC), Receive Operating Characteristic (ROC), Retrieval-Augmented Generation (RAG), normalization, hyperparameter, Tabular Data, Tabular Prior-Data Fitted Network (TabPFN), Symbolic Automatic INTegrator (SAINT), classifier, classification, classification task, training, annotated data, mean, average, standard deviation, confidence interval, bootstrapping, metric, probability, conditional probability, and probability distribution. These, as well as other similar terms, are well-known to someone with ordinary skills in the art and will be further described when required to illustrate a part of the instant solution.

The term “latent space”, also known as a “latent feature space” or “embedding space”, is an embedding of a set of items within a vector space, or more generally a manifold, in which items resembling each other are positioned closer to one another. The embedding vectors are often referred to as “latents”, “embeddings”, “embedding vectors”, or “vectors”. The terms vector, vector space, and manifold are well known to someone with ordinary skills in the art and will be further described when required to illustrate a part of the instant solution.

The disclosures of the instant solution are additionally expressed using the following well-known terms and techniques: “diffusion model”, “flow-based model”, “flow matching”, “ForestDiffusion”, and “ForestFlow”. A flow-based model is a type of generative model used in machine learning to model a probability distribution. A diffusion model is a type of generative model that creates new data by gradually transforming random noise into structured data. ForestDiffusion is a method of generating tabular data using a combination of diffusion and flow-based models. ForestFlow is a particular type of flow-matching model. These, and related terms, are well known to someone with ordinary skills in the art and will be further described when required to illustrate a part of the instant solution.

A Gradient Boosted Tree (GBT) is a machine learning algorithm that makes use of gradient descent for its calculations. GBT is an ensemble technique that combines multiple weak learners, typically decision trees, to create a stronger model. Decision Trees are predictive models that partition input data into distinct subsets via decision splits, culminating in terminal nodes, each providing a prediction. Decision Trees recursively partition the feature space to maximize the homogeneity of predictions within each partition. Gradient-Boosted Trees bring additional advantages, including not using significant pre-processing, efficient handling of missing data, and efficient training on Central Processing Units (CPUs) and vector processing units. XGBoost (extreme Gradient Boosting) is a well-known open-source library that provides implementations of gradient boosted decision trees and other gradient boosting algorithms. These, and related terms, are well known to someone with ordinary skills in the art and will be further described when required to illustrate a part of the instant solution.

The disclosure of the instant solution is expressed using terminology and concepts from computer systems and networking. Examples include, but are not limited to, Central Processing Unit (CPU), Graphics Processing Unit (GPU), Tensor Processing Unit (TPU), Neural Processing Unit (NPU), AI Processor (AIP), vector processor, memory, disk, storage, process, thread, client, server, node, host, virtual machine, stack, kernel, registers, segments, address space, networking, Transmission Control Protocol/Internet Protocol (TCP/IP), cloud, hosted, hosted node, cluster, operating system, containers and container management. These, as well as other similar terms, are well-known to someone with ordinary skills in the art and will be further described when required to illustrate a part of the instant solution.

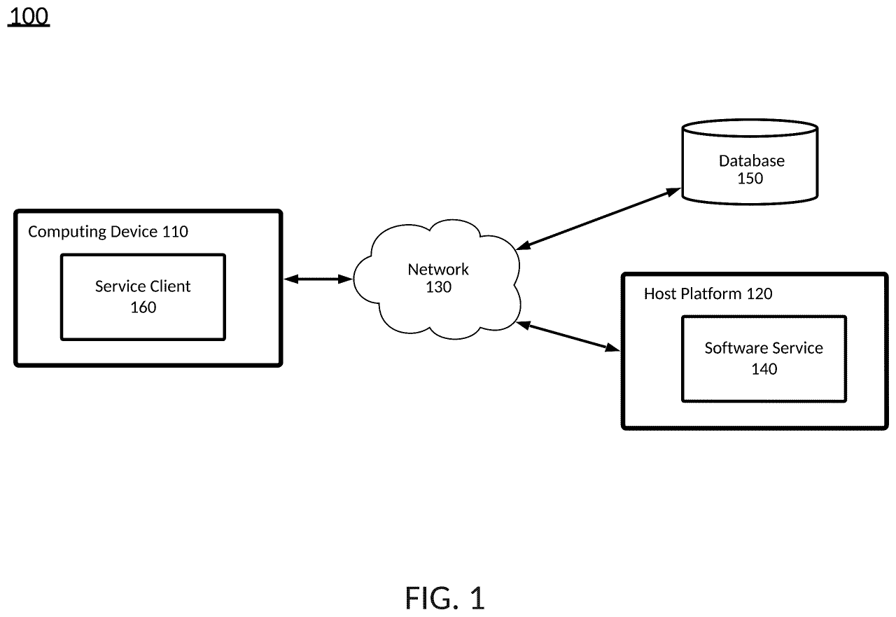

FIG. 1 is a system diagram illustrating an example operating environment 100 of the instant solution. As shown, at least one computing device 110, and a host platform 120 communicate via a network 130. The host platform 120 may host a software service 140. The software service 140 may communicate with at least one database 150 through a network 130 during the course of service execution. Each computing device 110 may host a service client 160, which communicates with a corresponding software service 140.

A computing device 110 may be a mobile phone, tablet, laptop computer, desktop computer, smartwatch, vehicle infotainment system, or any computing device including a processor and memory. The host platform 120 may include a single physical server, multiple physical servers, a cloud hosting environment, or a hybrid hosting environment in which some components of the host platform 120 are “on-premise” while others are cloud-hosted. The network 130 is a computer network and may include one or more interconnected computer networks. For example, network 130 may be or may include an Ethernet network, an asynchronous transfer mode (ATM) network, a wireless network, a telecommunications network or the like.

The software service 140 provides the service logic. It may provide one or more Application Programming Interfaces (APIs) for communicating with at least one service client 160. A “thick” user interface client that runs on a computing device 110 may utilize the APIs to communicate with the software service 140. Further, the software service 140 may provide hosted User Interfaces (UIs) that can be accessed through browser-based software on at least one computing device 110.

The at least one service client 160 can enable service access for end users and may come in a variety of forms including, but not limited to, a mobile device application (“app”) or a web portal accessed via a browser on a computing device 110 such as a laptop or desktop computer.

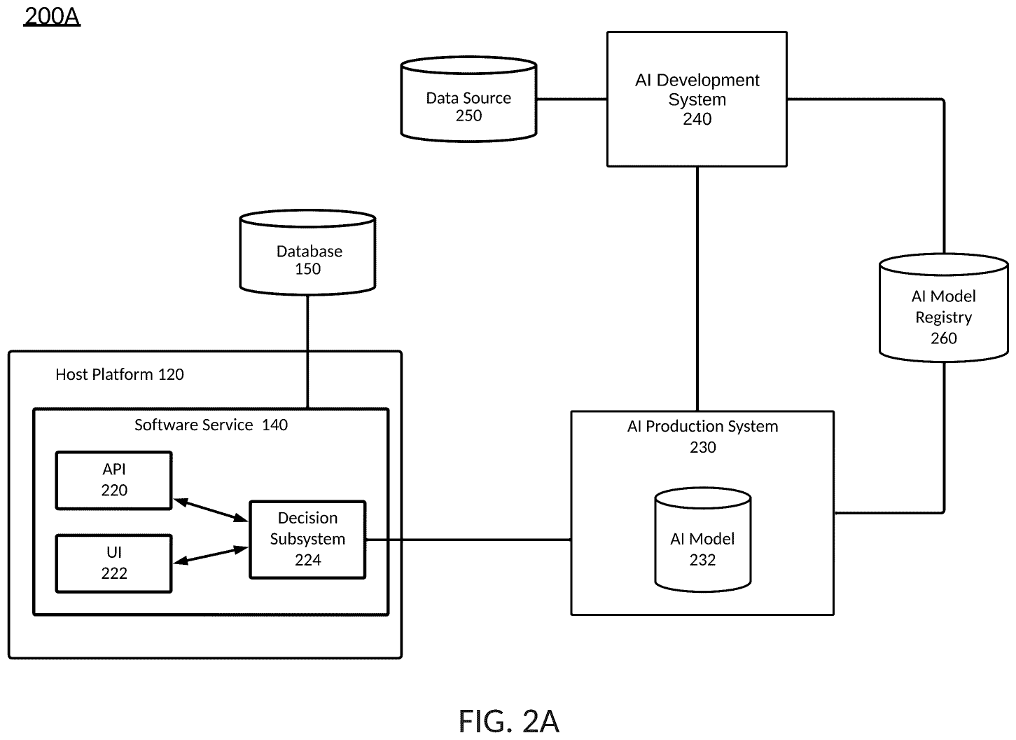

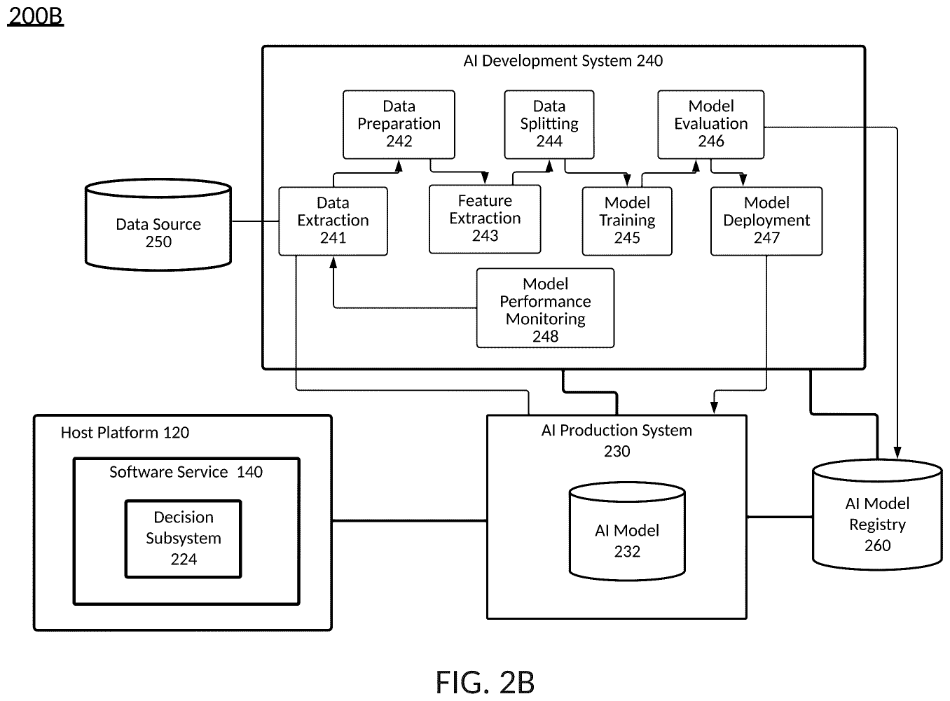

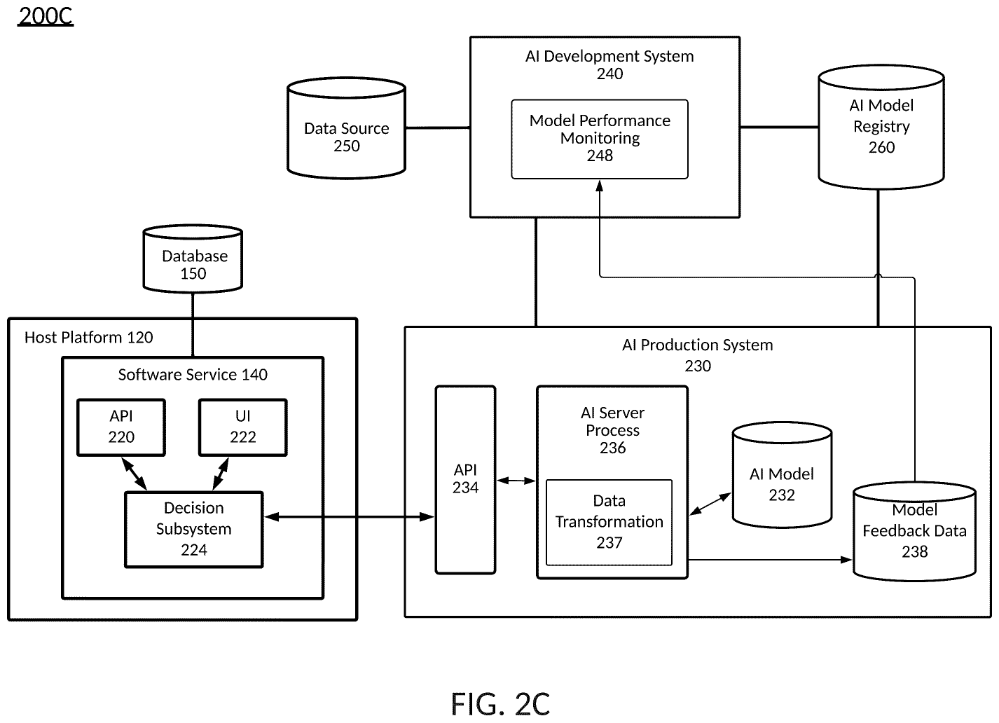

FIG. 2A illustrates an artificial intelligence (AI) network diagram 200A that supports AI-assisted Efficient Scaling of AI Models in a software service executing on a computer. While the example instant solution shown utilizes a scaling AI model, which is a type of machine learning (ML) model, other branches of AI, such as, but not limited to, computer vision, fuzzy logic, expert systems, neural networks, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, increasing its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 140 (see FIGS. 1, 2A), executing on the host platform 120 (see FIGS. 1, 2A) may provide at least one application programming interface (API) 220 that enable interaction with other software components via a set of data definitions and protocols. In some examples and features of the instant solution, the at least one API 220 provided may employ Simple Object Access Protocol (SOAP), Remote Procedure Calls (RPC), and Representational State Transfer (REST) techniques. In some examples and features of the instant solution, the at least one API 220 send data to at least one decision subsystem 224 of the software service 140 to assist in decision-making. In some examples and features of the instant solution, the software service 140 stores data included in API requests or data generated during processing the API requests into at least one database 150 (see FIGS. 1, 2A).

Software service 140 may provide at least one user interface (UI) 222, such as a server-side hosted graphical user interface (GUI). In some examples and features of the instant solution, the at least one UI 222 provided employ template-based frameworks, component-based frameworks, etc. In some examples and features of the instant solution, the at least one UI 222 send data to at least one decision subsystem 224 of the software service 140 to assist with decision-making. In some examples and features of the instant solution, the software service 140 stores data included in UI requests or data generated during processing the UI requests into at least one database 150.

Software service 140 may include at least one decision subsystem 224 that drive a decision-making process of the software service 140. In some examples and features of the instant solution, the at least one decision subsystem 224 receive data from at least one API 220 as input into the decision-making process. In some examples and features of the instant solution, a decision subsystem 224 may receive data from at least one UI 222 as input to the decision-making process. A decision subsystem 224 may gather service configuration or historical execution data from at least one database 150 to aid in the decision-making process. A decision subsystem 224 may provide feedback to an API 220 or a UI 222.

An AI production system 230 may be used by a decision subsystem 224 in a software service 140 to assist in its decision-making process. The AI production system 230 includes at least one AI model 232 that are executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates at least one AI model 232. In some examples and features of the instant solution, the AI development system 240 utilizes data from at least one data source 250 to develop and train at least one AI model 232. The at least one data source 250 may be local or third-party data sources. Further, the data provided by the data sources may be real-world or synthetic. In some examples and features of the instant solution, the AI development system 240 utilizes feedback data from at least one AI production system 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by at least one AI production system 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing one or more AI models that support AI-assisted decision points. An AI development system 240 executes steps to develop an AI model 232 that begins with data extraction 241, in which data is loaded and ingested from at least one data source 250. In some examples and features of the instant solution, historical model feedback data is extracted from at least one AI production system 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 242 may be a manual process or an automated process using one or more of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using one or more of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from the data splitting step 244. These steps may be repeated with adjustments to one or more algorithm parameters until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from the data splitting 244 step is used. In some examples and features of the instant solution, one or more unseen validation datasets are used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using one or more of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the at least one data source 250.

Once an AI model 232 has been validated and published to an AI model registry 260, it may be deployed during the model deployment step 247 to at least one AI production system 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes one or more triggers that result in the AI model 232 being updated by repeating steps 241-248 with updated data from at least one data source 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 140 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 140, UI 222 data from software service 140 or data from other software service 140 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from at least one other data source 250. Once the data transformation occurs, the AI server process 236 executes the appropriate AI model 232 using the transformed input data. Upon receiving the execution result, the AI server process 236 responds to the API requester, which is a decision subsystem 224 of software service 140. In some examples and features of the instant solution, the response may result in an update to a UI 222 in software service 140. In some examples and features of the instant solution, the response includes a request identifier that can be used later by the software service 140 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to a recent model accuracy falling below a pre-determined threshold. In some examples and features of the instant solution, the model feedback data 238 is used as an input to determine the recent model accuracy.

In some examples and features of the instant solution, the AI production system 230 includes a user interface (not shown). The user interface may be used to manage the production system infrastructure, the components of the production system 230-238, and the operation of the AI production system and its components.

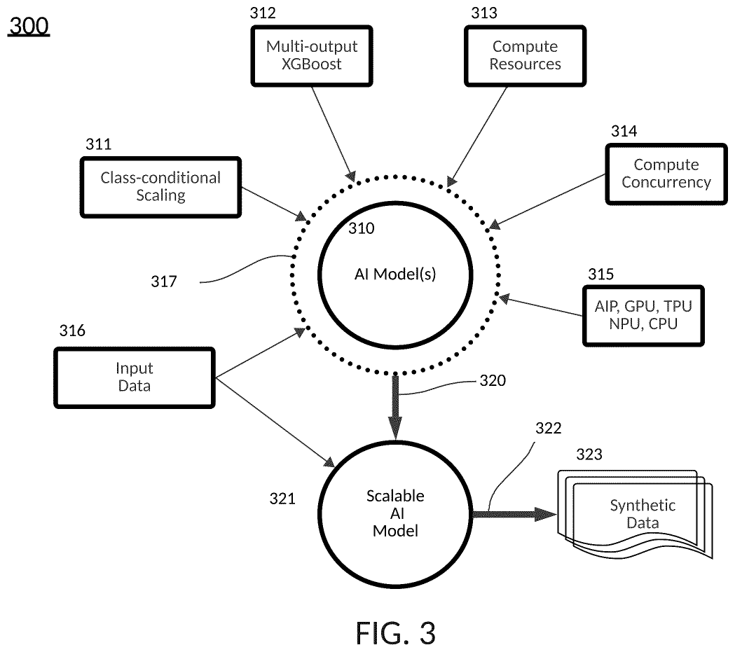

In some examples and features of the instant solution, FIG. 3 is a system diagram illustrating key aspects of an operating environment 300 of the instant solutions. The instant solution is a combination 317 of several techniques combined in a novel way to provide scalable generative modeling for diffusion and flow-matching AI models, such as AI models using ForestDiffusion and/or ForestFlow 310. The scalability features include one or more of class-conditional scaling 311, a multi-output XGBoost 312, reduction in the use of system compute resources 313 such as processing and memory, increased compute concurrency 314, and flexible use of at least one AIP, GPU, TPU, NPU and CPU 315.

In some examples and features of the instant solution, a combination 317 of one or more of the scalability features are combined to create 320 a scalable AI model 321 with increased performance and generative ability. The Scalable AI Model 321 is then used to generate 322 synthetic data 323 sets.

In some examples and features of the instant solution, multi-output XGBoost 312 increases the capabilities and efficiency of the standard XGBoost by regressing multiple output targets concurrently. The multi-output regression means that the XGBoost algorithm predicts multiple output targets in parallel. By default, the standard XGBoost builds one model for each target. The multi-output enhanced XGBoost naturally captures correlations between output variables during generation due to the use of a single regressor. The use of a single multi-output regression demands less processing and memory as one regression prediction is performed, instead of one for each model for each target in the standard XGBoost. This increases the efficiency and training of the scalable AI model 321.

The input data 316 to a ForestDiffusion model includes tabular data, a statistical noise generator (typically Gaussian), and optionally data such as labels and non-modified data known as covariates. The generative ForestDiffusion model generates realistic synthetic data 323 that mimics the statistical properties of the input data 316 sets and imputes missing values in the input data 316 set. The synthetic data 323 thus mimics the statistical properties of the input data 316 and may be used for a variety of purposes to augment the input data 316 or in-place of the input data 316.

In some examples and features of the instant solution, performance and resource efficiency are increased using class-conditional scaling 311. AI models using ForestDiffusion and ForestFlow 310 expect input data of the same scale. The instant solution refines the scaling by introducing class-condition scaling 311 comprising a minimum-maximum on the data being regressed. Class-conditional scaling centers data with large variations, thereby increasing overall model performance.

In some examples and features of the instant solution, performance and resource efficiency are increased for compute resources 313 by freeing memory held by XGBoost when no longer used. In another example and feature, datasets are loaded into shared memory and accessed by multiple worker-threads or worker-processes. This avoids copying data into each worker-process and thus reduces memory consumption and increases concurrency and scalability. In another example and feature, each model is unloaded from memory, i.e. deallocated, when trained instead of holding the model in memory. This reduces memory consumption and increases scalability. In another example and feature, the use of worker-threads and worker-processes distributes and may balance processing load, may increase performance, and may reduce overall energy consumption.

In some examples and features of the instant solution, arrays are stored in shared memory as memory-mapped files, which impact compute resources 313 and compute concurrency 314. This provides increased concurrency.

In some examples and features of the instant solution, calculations are performed in 32-bit floating point, 64-bit floating point or a combination thereof, using one or more of processors AIP, GPU, TPU, NPU, CPU 315. In an example, all calculations are performed in 32-bit floating point, using one or more of processors AIP, GPU, TPU, NPU, CPU 315. In another example, calculations are performed as vector operations on one or more of an AIP, GPU, TPU, NPU, or CPU 315, thus increasing performance over serial calculations on a general-purpose CPU.

In some examples and features of the instant solution, an AI model 310 is a combination 317 of one or more of class-conditional scaling 311, multi-output XGBoost 312, reduction of compute resources 313, increased compute concurrency 314, and utilization of AIP, GPU, TPU, NPU or CPU 315 to create 320 a scalable AI model 321. The scalable AI model 321 is then used to generate 322 one or more synthetic data 323 sets. The synthetic data 323 mimics the statistical properties of the input data 316 and may be used for a variety of purposes including augmentation of the input data 316 set, used in-place of the input data 316 to keep the input data private, used to diversify the input data 316 with similar data, used to train another model on the synthetic data 323, used as input by another model, or other uses of data statistically similar to the input data 316.

In some examples and features of the instant solution, the operating environment 300 may be an example of an AI development system 240 as described and depicted in FIGS. 2A-2C. In some examples and features of the instant solution, input data 316, refinements to class-conditional scaling 311, refinements to multi-output XGBoost 312, reduction to compute resources 313, increases to compute concurrency 314, flexible use of at least one AIP, GPU, TPU, NPU and CPU 315, an AI model 310 using ForestDiffusion and/or ForestFlow, a scalable AI model 321, and synthetic data 323 may be retrieved from and/or may be stored in at least one data source 250, as described and depicted in FIGS. 2A-2C. In some examples and features of the instant solution, refinements to class-conditional scaling 311, refinements to multi-output XGBoost 312, reduction to compute resources 313, increases to compute concurrency 314, flexible use of at least one AIP, GPU, TPU, NPU and CPU 315, an AI model using ForestDiffusion and/or ForestFlow 310, and a scalable AI model 321 may include data extraction 241, data preparation 242, feature extraction 243, data splitting 244, model training 245, model evaluation 246, model deployment 247, and/or model performance monitoring 248, as described and depicted in FIGS. 2A-2C. In some examples and features of the instant solution the AI model 310 and the scalable AI model 321 may be examples of AI model 232, as described and depicted in FIGS. 2A-2C.

One practical application of the instant solution is generating refined synthetic data 323 from input tabular data as described and depicted in FIG. 3 and herein.

Another practical application of the instant solution is to use the generated synthetic data 323 as input to train or run another model, as described and depicted in FIG. 3 and herein.

Another practical application of the instant solution is to use the generated synthetic data 323 instead of the input data to preserve the privacy of the input data 316 as described and depicted in FIG. 3 and herein.

Another practical application of the instant solution is to use the generated synthetic data 323 to augment the input data 316 for other machine learning purposes, as described and depicted in FIG. 3 and herein.

Another practical application of the instant solution is regressing using a multi-output Gradient Boosting, such as multi-output XGBoost 312. This reduces requirements for processing cycles and memory, as described and depicted in FIG. 3 and herein.

Another practical application of the instant solution is refining the dynamic range of an AI model 310 by class-conditional scaling 311 of the input tabular data, as described and depicted in FIG. 3 and herein.

Another practical application of the instant solution is reducing compute resources 313 such as memory and processor utilization by one or more of sharing data between processes, using shared memory, sharing memory using memory-mapped files, freeing allocated resources when no longer used, and performing calculations in the same floating-point resolution or as floating-point vector operations, as described and depicted in FIG. 3 and herein.

Another practical application of the instant solution is to increase compute concurrency 314 by at least one of sharing data between processes, using shared memory, and sharing memory using memory-mapped files, thereby avoiding copying data into one or more worker-processes, as described and depicted in FIG. 3 and herein.

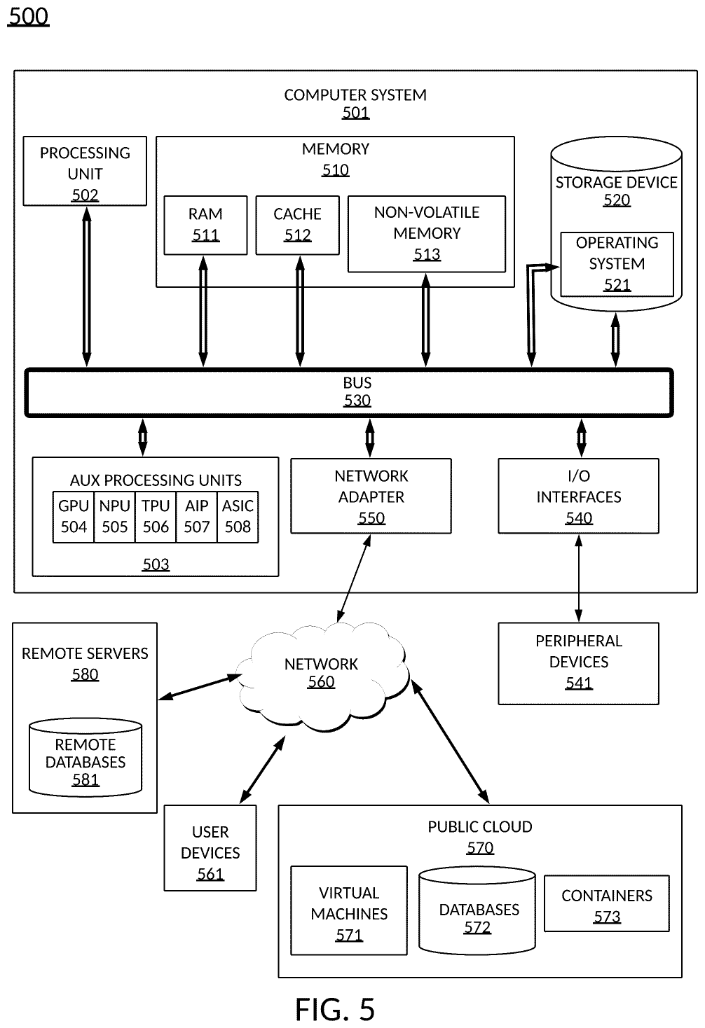

Another practical application of the instant solution is using auxiliary processing units to augment the processing and reduce processor utilization of the processing unit, for example 502 (FIG. 5), as described and depicted in FIG. 3 and herein.

The technical problem addressed by the instant solution, as depicted in FIG. 3, centers around the challenges associated with efficiently scaling AI models, particularly in handling large-scale tabular datasets and computationally intensive tasks. Traditional approaches to scaling AI models face significant limitations, including excessive memory consumption, slow processing times, and inefficiencies in resource utilization. These issues are exacerbated by the increasing complexity of AI models, which expect concurrent processing of vast amounts of data while maintaining high accuracy and performance. The inefficiencies of existing systems are further compounded when dealing with diverse hardware environments, where the lack of optimized resource management leads to bottlenecks and reduced scalability.

Conventional AI scaling techniques are expected to address workloads' dynamic nature, which can vary depending on the specific application or operational environment. For instance, the static allocation of computational tasks to processing units, such as CPUs, GPUs, or TPUs, often results in suboptimal performance due to the inability to adapt to real-time changes in workload demands. This rigid approach limits the scalability and efficiency of AI models, particularly in environments requiring real-time processing and rapid decision-making, such as autonomous systems or large-scale data analytics platforms. The instant solution overcomes these technical problems by introducing innovative resource reduction techniques, flexible use of multiple processing units, and intelligent workload management strategies that provide a scalable, efficient, and adaptable AI model deployment framework.

The technical solution provided by the instant solution, as illustrated in FIG. 3, involves a multifaceted approach to enhancing the scalability and efficiency of AI models, particularly in handling large-scale tabular datasets and computationally demanding tasks. Central to this solution is integrating resource reduction techniques, such as memory sharing and vector operations associated with compute resources 313 and AIP, GPU, TPU, NPU, CPU 315, which minimize memory overhead and accelerate data processing. By allowing multiple processes to access shared data in memory, the system reduces duplication and increases communication efficiency, leading to a more streamlined operation to manage larger datasets and more complex models within the same hardware constraints. Additionally, vector operations are optimized to leverage the parallel processing capabilities of modern hardware, such as GPUs and TPUs, enabling faster and more efficient computations for scaling AI models effectively.

Another key component of the technical solution is the flexible use of diverse processing units, including AIP, GPU, TPU, NPU, CPU 315. This flexibility allows the system to dynamically allocate computational tasks based on the specific strengths of each processing unit, ensuring that resources are utilized in the most efficient manner possible. For example, tasks that involve large-scale matrix multiplications can be directed to GPUs, which excel in parallel processing, while tensor operations are handled by TPUs, which are optimized for such tasks. This intelligent allocation enhances processing speed and ensures that the system remains adaptable to varying workloads, thereby overcoming the limitations of static resource allocation seen in traditional systems. Combining and prioritizing these processing units based on real-time workload demands further enhances the scalability of the AI model, making it capable of handling complex, high-dimensional data resource-efficiently.

The solution incorporates increased compute concurrency 314, which allows the system to manage and process multiple data streams simultaneously. These are particularly beneficial in distributed and edge computing environments, where AI models are deployed across multiple nodes or devices with varying computational capabilities. By enabling concurrent processing and optimizing resource sharing, the system can scale across distributed infrastructures, ensuring performance and reduced latency even as the size and complexity of the datasets increase.

A technical advantage of class-conditional scaling 311, as described and depicted in FIG. 3, is its ability to dynamically adjust input data scaling based on each class's inherent characteristics within a dataset. This approach goes beyond the traditional minimum-maximum or z-score normalization techniques, which apply uniform scaling across all data points without considering class-specific distributions. By incorporating class-conditional scaling, the instant solution centers and normalizes data, enhancing the homogeneity of input features within each class. This targeted scaling increases the learning efficiency of AI models, as it reduces the variability that a model is expected to handle when processing input data, particularly in complex multi-class classification tasks.

Class-conditional scaling contributes to more stable and accurate gradient calculations during the training phase of AI models. This stability leads to faster convergence and generalization on unseen data, as the model is less prone to overfitting to the dominant features of larger classes. Integrating class-conditional scaling with multi-output XGBoost 312, further optimizes the resource allocation during model training, ensuring that computational resources are efficiently utilized by focusing on class-specific patterns rather than global data trends.

As illustrated in FIG. 3, class-conditional scaling 311 offers advantages over existing methods, particularly when applied to datasets with diverse class distributions and varying feature ranges. For example, in medical diagnosis datasets, where different classes (e.g., disease presence vs. absence) may have vastly different feature distributions, traditional scaling methods may obscure these subtle patterns. By applying class-conditional scaling, the instant solution ensures that each class is scaled independently, preserving the integrity of class-specific characteristics and enhancing the model's ability to differentiate between classes with similar feature values.

A practical example of this approach can be observed in financial fraud detection scenarios, where the dataset comprises transactions labeled as fraudulent or legitimate. Fraudulent transactions are often fewer in number but exhibit distinctive patterns compared to legitimate transactions. Utilizing class-conditional scaling enables the model to amplify these subtle fraud-related patterns by scaling the features within the fraudulent class separately from the legitimate ones. This tailored scaling approach increases the model's sensitivity to detecting fraud, reducing false negatives and enhancing overall detection accuracy.

Class-conditional scaling is applied in scenarios involving imbalanced datasets, such as customer segmentation in marketing or rare event prediction in industrial systems. In these cases, the ability to scale features based on class-specific statistics prevents the dominant class from overshadowing the minority class, allowing the model to capture insights from less frequent yet relevant classes. By preserving the feature distributions of each class, class-conditional scaling increases classification accuracy and facilitates the development of more robust and reliable AI models capable of performing well across a wide range of applications and domains.

Combining class-conditional scaling 311 with other scaling techniques, particularly when integrated with the multi-output XGBoost 312 as shown in FIG. 3, represents a non-obvious and innovative approach to enhancing AI model performance. By employing class-conditional scaling alongside traditional scaling methods, such as min-max or z-score normalization, the instant solution achieves a balanced and optimized input data preparation process that addresses the challenges of heterogeneous datasets. This dual-scaling approach allows the multi-output XGBoost to operate more effectively, as the data is preprocessed to accentuate the features within each class while maintaining overall feature consistency across the dataset.

In one example of the instant solution, class-conditional scaling is first applied to normalize the features within each class independently, ensuring that the internal class distributions are centered and scaled appropriately. Subsequently, a secondary scaling technique, such as global min-max normalization, is applied to align the features across different classes, providing a uniform range that facilitates effective gradient boosting in the multi-output XGBoost model. This layered scaling process reduces the internal variance within each class and mitigates the impact of outliers, resulting in a more stable and accurate model training phase.

Non-obvious combination of scaling techniques, when applied to multi-output regression tasks, increases model accuracy and resource efficiency. The multi-output XGBoost benefits from the reduced complexity in the input data. The class-conditional scaling preemptively addresses the disparities between class distributions, allowing the model to focus on learning the relationships between features rather than compensating for inconsistencies in the data. The reduced complexity results in a more efficient use of computational resources, with faster convergence times and lower memory usage, as the model uses fewer iterations to achieve optimal performance.

The increase in model accuracy is attributed to the enhanced ability of the multi-output XGBoost to capture intricate patterns and dependencies within the data often missed by conventional scaling methods. By leveraging the strengths of both class-conditional and global scaling, the instant solution provides a comprehensive and powerful data preprocessing strategy that enhances the performance of AI models across a wide range of applications, from predictive analytics to large-scale data synthesis.

The multi-output XGBoost 312 in FIG. 3 provides a robust technological solution to the challenges of efficiently handling large-scale tabular data, particularly in scenarios involving complex, multi-dimensional datasets. Traditional gradient boosting techniques often use separate models for each target variable, which can result in computational overhead, especially when dealing with large datasets. The multi-output XGBoost, however, streamlines this process by predicting multiple output variables within a single model in parallel, thereby reducing the computational burden and optimizing resource utilization.

In the example of the instant solution, the multi-output XGBoost is particularly advantageous in scenarios where there is a demand to predict several interrelated outcomes based on a common set of input features. For example, in financial modeling, where multiple economic indicators may be forecasted from a shared set of predictors, the multi-output XGBoost can efficiently learn the relationships between these indicators and their shared features. By consolidating the learning process into a single model, the minimization of redundancy and memory usage associated with training multiple models lead to a more scalable and resource-efficient solution.

The model's ability to capture the correlations between different output variables within a unified framework enhances predictive accuracy and reduces the training time and computational resources. The architecture of the multi-output XGBoost allows for shared computation across outputs, which translates into fewer operations and reduced latency during training and inference stages. The model's integration with scalable hardware accelerators, such as GPUs or TPUs, further amplifies these efficiencies, enabling processing vast datasets in a fraction of the time of conventional methods.

This technological advancement in handling large-scale tabular data demonstrates the practical benefits of multi-output XGBoost and may apply to various domains.

The multi-output capability of XGBoost may be used in several specific use cases and datasets where traditional single-output models are unable to perform effectively. One such use case is environmental modeling, where predicting multiple interdependent variables, such as temperature, humidity, and air quality indices, assists in accurate forecasting and analysis. The multi-output XGBoost may model these variables in parallel, leveraging their correlations to enhance prediction accuracy. This capability is particularly valuable when these environmental factors are influenced by shared underlying conditions, such as geographic location or time of day.

Another example use case is in healthcare, specifically in personalized medicine, where multiple biomarkers are often used to predict patient outcomes. For example, predicting the progression of chronic diseases might consider several biomarkers, such as blood pressure, cholesterol levels, and glucose concentration. The multi-output XGBoost may efficiently handle this complexity by modeling these biomarkers within a single framework, capturing their interdependencies, and providing a more comprehensive prediction of patient outcomes. This approach increases the predictive power and reduces the computational resources, compared to running multiple single-output models, a limitation of existing methods.

In the financial sector, multi-output XGBoost may be used for portfolio management tasks, such as predicting future performance. Each asset's performance is not independent of others, as they often move together due to market conditions, economic indicators, or company-specific news. The multi-output capability allows the model to understand and exploit these relationships, leading to more accurate and robust portfolio predictions. The single-output capability treats each asset as a separate prediction task, thereby missing the opportunity to model the shared influences between assets, which can result in suboptimal portfolio strategies.

Multi-output models may be used in these complex scenarios, demonstrating that this capability provides an advantage over prior approaches.

An inventive step is introduced by integrating the multi-output XGBoost 312 with other AI or ML models, creating a hybrid approach that enhances predictive accuracy and computational efficiency beyond what is achievable with single-output or traditional XGBoost implementations. One example of the instant solution combines multi-output XGBoost with deep neural networks (DNNs) in a sequential modeling architecture. The DNN is employed as a feature extractor in this configuration, processing raw input data to capture complex, non-linear relationships and generating a rich feature set as input to the multi-output XGBoost. This integration leverages the strengths of both models—the DNN's ability to learn high-level abstractions and the XGBoost's capability to handle tabular data with gradient boosting, resulting in a system that excels in scenarios requiring both feature learning and efficient, accurate predictions.

For example, in genomics, where predicting multiple phenotypic traits is based on genomic sequences, this hybrid model provides refinements over traditional approaches. The DNN can process raw genomic data, such as DNA sequences, extracting features that are input into the multi-output XGBoost to predict various traits in parallel. This approach reduces the dimensionality of the input space and increases the model's ability to generalize across different genomic datasets, addressing a limitation in which separate models are employed for each trait.

Another example of the instant solution may integrate multi-output XGBoost with reinforcement learning (RL) frameworks, where the XGBoost model acts as a critic within the RL loop, providing multi-output value estimates for different actions in an environment. This integration is valuable in complex decision-making tasks, such as autonomous driving or robotic control, where multiple factors, such as speed, direction, and obstacle proximity, are to be predicted and optimized in parallel. The multi-output XGBoost enhances the RL agent's ability to evaluate the potential outcomes of actions more accurately, leading to policy learning and decision-making efficiency.

Resource reduction techniques associated with compute resources 313 and AIP, GPU, TPU, NPU, CPU 315 in FIG. 3, such as memory sharing and vector operations, provide increased scalability of AI models by optimizing the utilization of computational resources and minimizing memory overhead. These techniques are particularly useful in large-scale deployments where the data volume and the models' complexity can strain system resources. Memory sharing, for example, allows multiple worker processes to access the same data in memory without duplicating data across processes. This approach reduces the overall memory footprint of the AI model, enabling the system to handle larger datasets and more complex models within the same hardware constraints. By avoiding the duplication of data, memory sharing also facilitates faster inter-process communication, which is used for maintaining high concurrency levels and ensuring that the AI model can scale efficiently across distributed systems.

Vector operations further enhance scalability by leveraging the parallel processing capabilities of modern hardware, such as GPUs, TPUs, and NPUs. These operations allow for the execution of multiple computations, accelerating the processing of large datasets and complex algorithms. By utilizing vector operations, the AI model can perform calculations more efficiently, reducing the time used for training and inference and allowing the system to scale to larger and more intricate datasets without a proportional increase in processing time.

Resource reduction techniques lead to increased performance and scalability of AI models. Integrating memory sharing and vector operations into AI frameworks can reduce memory usage and increase processing speed by several orders of magnitude, depending on the specific hardware configuration and dataset size. These advancements make it feasible to deploy AI models in resource-constrained environments and provide new possibilities for scaling AI systems across cloud and edge computing platforms, where efficient resource management is expected.

The resource reduction techniques, including memory sharing and vector operations, associated with compute resources 313 and AIP, GPU, TPU, NPU, CPU 315 of FIG. 3, can be applied to specific AI models, thereby extending the applicability and enhancing the performance of these models in novel contexts. In one example of the instant solution, these techniques are applied in federated learning environments, where multiple decentralized devices collaboratively train a shared AI model while keeping the data localized on each device. In this scenario, memory sharing becomes particularly valuable as it efficiently manages shared model parameters across different devices without redundant data storage. Each device can access and update shared model parameters in real-time by utilizing memory sharing, reducing memory consumption and communication overhead, which are bottlenecks in federated learning setups.

Vector operations can be leveraged in this federated learning context to accelerate the processing of large datasets distributed across various devices. Given the heterogeneity of devices in such environments, from smartphones to edge servers, vector operations can be customized to match the specific hardware capabilities of each device, ensuring optimal performance. For example, devices equipped with GPUs can execute more complex vector operations in parallel, while those with less powerful hardware can still benefit from optimized scalar operations. This adaptability increases the scalability of the federated learning system and also ensures that resource-constrained devices can participate effectively in the training process, thus broadening the potential applications of federated learning.

Another example of the instant solution involves deploying these resource reduction techniques in real-time AI-driven systems, such as autonomous vehicles or industrial automation processes, which demand computational efficiency and rapid decision-making. In these environments, memory sharing allows different subsystems, such as sensor processing units and decision-making algorithms, to access common data structures without duplication. This leads to faster data processing and reduces the overall system latency for maintaining the real-time performance in such applications. Vector operations enable these systems to process high-dimensional sensor data, such as light detection and ranging (LIDAR) or camera feeds, more efficiently, facilitating quicker and more accurate responses to environmental changes.

The combining of multiple resource reduction techniques associated with computing resources 313 and AIP, GPU, TPU, NPU, CPU 315 in FIG. 3 addresses the limitations of existing systems by enhancing the scalability and efficiency of AI models. This combination includes integrating memory sharing and vector operations and utilizing specialized processing units like GPUs, TPUs, and NPUs. Each technique contributes to reducing computational overhead.

For example, memory sharing alone reduces data redundancy across multiple processes, thereby decreasing memory usage. When combined with vector operations, which enable parallel data processing, the system minimizes memory overhead and also accelerates computation, particularly in environments with high-dimensional data, such as image or video processing tasks. This dual approach allows for the efficient management of large-scale datasets, enabling AI models to process data faster while maintaining or increasing accuracy.

When these techniques are combined with deploying specialized hardware like GPUs and TPUs, the AI model can handle even more complex computations with greater speed and efficiency. Using vector operations on these specialized units leverages their inherent parallel processing capabilities, reducing the time for model training and inference phases. This is advantageous in real-time applications, such as autonomous systems or financial trading platforms, where processing speed and decision accuracy are expected.

This combination addresses the limitations of existing systems, which often struggle with scalability and resource management, and also sets a new standard for efficiency in AI model deployment. By overcoming these challenges, the system enables the development of more robust, high-performance AI applications that can operate in resource-constrained environments without sacrificing accuracy or speed.

The non-obviousness of the increased concurrency associated with compute concurrency 314 of FIG. 3 is further exemplified when these enhancements are combined with specific hardware or software configurations, resulting in benefits that advance the system. One example of the instant solution involves integrating the increased concurrency with a distributed computing environment where AI models are deployed across multiple nodes in a cloud infrastructure. The system can manage and process large-scale datasets concurrently across these distributed nodes by utilizing memory sharing in combination with vector operations on specialized hardware such as GPUs and NPUs. This approach enhances the system's overall throughput and also ensures that the computational load is balanced dynamically, reducing bottlenecks common in traditional distributed AI systems.

When increased concurrency is paired with software configurations supporting containerized deployments, such as containerized orchestration, the system can automatically scale AI model training and inference based on real-time demand. This example of the instant solution leverages the increased concurrency to ensure that containerized instances of the AI model can efficiently share resources and execute vector operations in parallel, even as the system scales. The result is efficient resource utilization, with reduced latency and increased responsiveness, particularly in high-demand scenarios such as real-time analytics or large-scale simulations.

In another example of the instant solution, increased concurrency is combined with edge computing configurations, where AI models are deployed on devices with limited computational power, such as internet of things (IoT) devices or mobile platforms. In this context, the increased concurrency allows for the parallel processing of multiple data streams on resource-constrained hardware. By implementing memory-sharing techniques and optimizing vector operations for the specific architecture of edge devices, the system can perform complex computations locally without constant communication with centralized servers. This reduces latency and preserves bandwidth, making it feasible to deploy sophisticated AI models in environments where connectivity may be intermittent or unreliable.

The flexible use of various processing units, such as AIP, GPU, TPU, NPU, CPU 315 in FIG. 3, directly addresses the technical problems related to AI model scalability and resource management and provides a practical implementation. One of the challenges in scaling AI models is the demand to efficiently manage diverse computational workloads that can vary depending on the task's nature, the dataset's size, and the model architecture. The instant solution offers a novel approach by allowing seamless integration and utilization of multiple types of processing units, such as GPUs, TPUs, NPUs, and AIPs, each tailored to handle different aspects of the computational load.

For example, GPUs are particularly well-suited for parallel processing of large matrices, which is common in deep learning models. In contrast, TPUs are optimized for the specific demands of tensor computations, which are integral to many modern AI frameworks, especially those involving neural networks. By leveraging the strengths of each processing unit, the system can dynamically allocate tasks to the most appropriate hardware, ensuring that computational resources are used optimally. This flexibility increases the speed and efficiency of model training and inference and allows the system to scale effectively as the model's complexity or data volume increases. The system's ability to combine these processing units in a heterogeneous computing environment addresses the issue of resource management, particularly in scenarios where computational demands are unpredictable or vary over time. By distributing workloads across different processing units based on real-time analysis of the system's demands, the solution reduces bottlenecks and ensures that no single unit causes lowered performance. This dynamic management of resources is a concrete technical advancement that directly enhances the scalability of AI models, enabling them to operate efficiently across a wide range of hardware configurations and application domains.

The flexible use of diverse processing units can lead to increased performance and scalability. For example, experiments have shown that AI models deployed using this method achieve faster convergence times and more efficient resource utilization than systems that rely on a single processing unit.

The combination of these various processing units leads to significant and non-obvious increases in AI model performance and efficiency, particularly when these units are prioritized based on the specific workload. This approach allows the system to allocate computational tasks to the most suitable processing units, such as GPUs, TPUs, NPUs, or AIPs, depending on the nature and intensity of the tasks. For example, during the training of a deep learning model, the system may prioritize GPUs for handling matrix multiplications and convolutions due to their superior parallel processing capabilities. At the same time, NPUs or TPUs may be employed for tasks involving tensor operations or neural network computations, leveraging their specialized architectures for optimal performance.

An example scenario where this combination yields benefits is in real-time data processing environments, such as autonomous driving systems where the workload can vary, requiring rapid image data processing, sensor fusion, and decision-making algorithms. By assigning image processing tasks to GPUs, tensor computations to TPUs, and decision-making algorithms to NPUs, the system ensures that each component operates at peak efficiency, thereby reducing latency and enhancing the overall responsiveness of the AI model.

The non-obviousness of this approach becomes apparent when considering the conventional methods where a single type of processing unit might be used for all tasks, leading to inefficiencies and potential bottlenecks. By contrast, the inventive combination of processing units in a workload-aware manner eliminates these bottlenecks, enabling the system to handle more complex tasks without a proportional increase in resource consumption. The system's ability to reallocate tasks in real-time based on the current workload further enhances its adaptability, making it possible to maintain high-performance levels even under varying operational conditions.

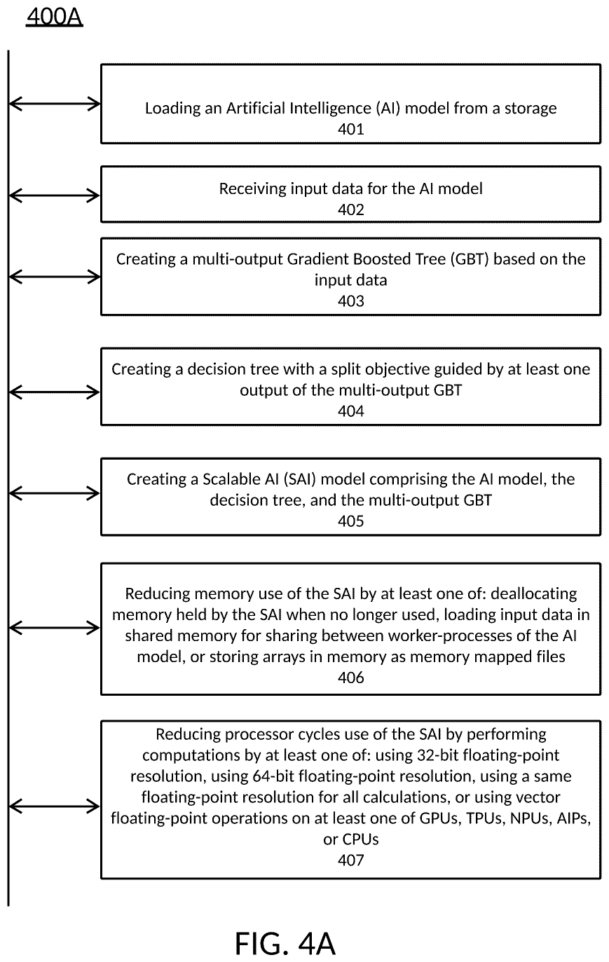

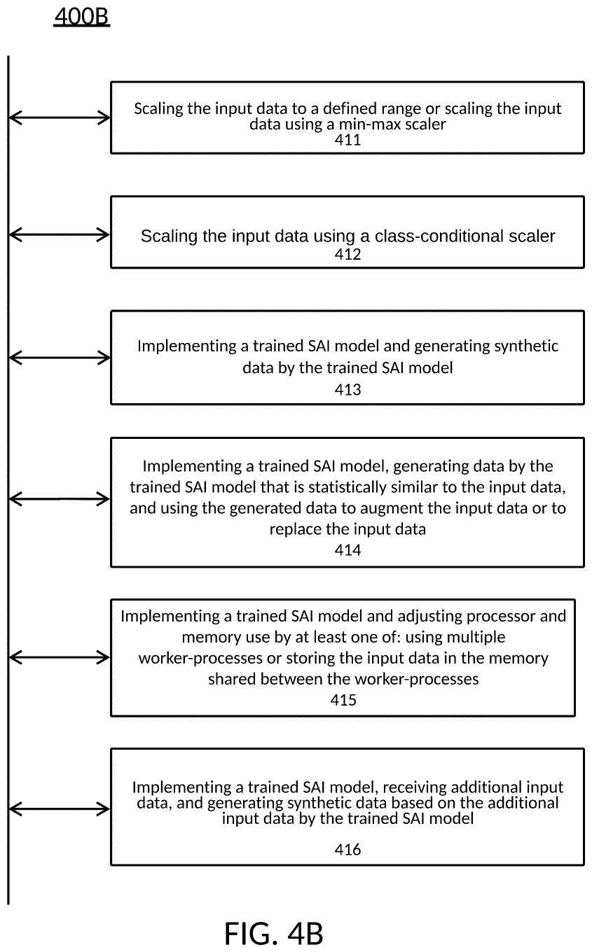

FIG. 4A is a diagram illustrating a method 400A of efficient scaling of AI models, according to examples and features of the instant solution. For example, the method 400A may be performed by at least one processor of a host platform such as a cloud platform, a web server, a software application, a combination of systems, and the like. Referring to FIG. 4A, in 401, the method may include loading an Artificial Intelligence (AI) model from a storage. In 402, the method may include receiving input data for the AI model. In 403, the method may include creating a multi-output Gradient Boosted Tree (GBT) based on the input data. In 404, the method may include creating a decision tree with a split objective guided by at least one output of the multi-output GBT. In 405, the method may include creating a Scalable AI (SAI) model comprising the AI model, the decision tree, and the multi-output GBT. In 406, the method may include reducing memory use of the SAI by at least one of: deallocating memory held by the SAI when no longer used, loading input data in shared memory for sharing between worker-processes of the AI model, or storing arrays in memory as memory mapped files. In 407, the method may include reducing processor cycles use of the SAI by performing computations by at least one of: using 32-bit floating-point resolution, using 64-bit floating-point resolution, using a same floating-point resolution for all calculations, or using vector floating-point operations on at least one of Graphical Processing Units (GPUs), Tensor Processing Units (TPUs), Neural Processing Units (NPUs), Artificial Intelligence Processors (AIPs), or Central Processing Units (CPUs).

FIG. 4B is another diagram illustrating a method 400B of efficient scaling AI models, according to examples and features of the instant solution. For example, the method 400B may be performed by at least one processor of a host platform such as a cloud platform, a web server, a software application, a combination of systems, and the like. Referring to FIG. 4B, in 411, the method may include scaling the input data to a defined range or scaling the input data using a min-max scaler. In 412, the method may include scaling the input data using a class-conditional scaler. In 413, the method may include implementing a trained SAI model and generating synthetic data by the trained SAI model. In 414, the method may include Implementing a trained SAI model, generating data by the trained SAI model that is statistically similar to the input data, and using the generated data to augment the input data or to replace the input data. In 415, the method may include implementing a trained SAI model and adjusting processor and memory use by at least one of: using multiple worker-processes or storing the input data in the memory shared between the worker-processes. In 416, the method may include implementing a trained SAI model, receiving additional input data, and generating synthetic data based on the additional input data by the trained SAI model.

The examples and features of the instant solution may be implemented in one or more of the elements described or depicted herein, including for example, the elements described or depicted in FIG. 5. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 5 illustrates an example computer system architecture, which may represent or be integrated in any of the above-described components, etc.

FIG. 5 illustrates a computing environment according to the instant solution's example features, structures, or characteristics. FIG. 5 is not intended to suggest any limitation as to the scope of use or functionality of features, structures, or characteristics of the instant solution of the application described herein. Regardless, the computing environment 500 can be implemented to perform any of the functionalities described herein. In computing environment 500, there is a computer system 501, operational within numerous other general-purpose or special-purpose computing system environments or configurations.

Computer system 501 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 560 or querying a database. Depending upon the technology, the performance of a computer-implemented method may be distributed among multiple computers and among multiple locations. However, in this presentation of the computing environment 500, a detailed discussion is focused on a single computer, specifically computer system 501, to keep the presentation as simple as possible.

Computer system 501 may be located in a cloud, even though it is not shown in a cloud in FIG. 5. On the other hand, computer system 501 may not be in a cloud except to any extent as may be affirmatively indicated. Computer system 501 may be described in the general context of computer system-executable instructions, such as program modules, executed by a computer system 501. Generally, program modules may include routines, programs, objects, components, logic, data structures, and so on that perform tasks or implement certain abstract data types. As shown in FIG. 5, computer system 501 in computing environment 500 is shown in the form of a general-purpose computing device. The components of computer system 501 may include but are not limited to, at least one processor or processing unit 502, a system memory 510, and a bus 530 that couples various system components, including system memory 510 to processing unit 502.

Processing unit 502 includes at least one computer processor of any type now known or to be developed. The processing unit 502 may contain circuitry distributed over multiple integrated circuit chips. The processing unit 502 may also implement multiple processor threads and multiple processor cores. Cache 512 is a memory that may be in the processor chip package(s) or located “off-chip,” as depicted in FIG. 5. Cache 512 is typically used for data or code accessed by the threads or cores running on the processing unit 502. In some computing environments, processing unit 502 may be designed to work with qubits and perform quantum computing.

The Auxiliary Processing Units (APU) 503 may contain one or more Graphics Processing Units (GPU) 504, Neural Processing Units (NPU) 505, Tensor Processing Units (TPU) 506, AI Processor (AIP) 507, or other Application Specific Integrated Circuit (ASIC) 508. Each of the APUs 503 may contain circuitry distributed over multiple integrated circuit chips. Each APU 503 may implement multiple processor threads and multiple processor cores. Each APU 503 may include one or more of onboard memory, onboard memory cache, and onboard instruction cache. Each APU may be communicatively coupled to the system bus 530 and configure to communicate with other system components, including a processing unit 502, system cache 512, RAM 511, non-volatile RAM 513, operating system 521, Network adapter 550, and Input/Output interfaces 540. In some computing environments, one or more of the APUs 503 may be designed to work with qubits and perform quantum computing.

Memory 510 is any volatile memory now known or to be developed in the future. Examples include dynamic random-access memory (RAM) 511 or static type RAM 511. Typically, the volatile memory is characterized by random access, but this may not be the characterization unless affirmatively indicated. In computer system 501, memory 510 is in a single package. It is internal to computer system 501, but alternatively or additionally, the volatile memory may be distributed over multiple packages and/or located externally with respect to computer system 501. By way of example, memory 510 can be provided for reading from and writing to a non-removable, non-volatile magnetic media (shown as storage device 520, and typically called a “hard drive”). Memory 510 may include at least one program product having a set (e.g., at least one) of program modules configured to carry out the functions of various features, structures, or characteristics of the instant solution of the application. A typical computer system 501 may include cache 512, a specialized volatile memory generally faster than RAM 511 and generally located closer to the processing unit 502. Cache 512 stores frequently accessed data and instructions accessed by the processing unit 502 to speed up processing time. The computer system 501 may also include non-volatile memory 513 in the form of ROM, PROM, EEPROM, and flash memory. Non-volatile memory 513 often contains programming instructions for starting the computer, including the basic input/output system (BIOS) and information to start the operating system 521.

Computer system 501 may include a removable/non-removable, volatile/non-volatile computer storage device 520. For example, storage device 520 can be a non-removable, non-volatile magnetic media (not shown and typically called a “hard drive”). At least one data interface can connect it to the bus 530. In features, structures, or characteristics of the instant solution where computer system 501 has a large amount of storage (for example, where computer system 501 locally stores and manages a large database), then this storage may be provided by peripheral storage devices 520 designed for storing very large amounts of data, such as a storage area network (SAN) that is shared by multiple, geographically distributed computers.

The operating system 521 is software that manages computer system 501 hardware resources and provides common services for computer programs. Operating system 521 may take several forms, such as various known proprietary operating systems or open-source Portable Operating System Interface type operating systems that employ a kernel.

The bus 530 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 530 is the signal conduction path that allows the various components of computer system 501 to communicate.

Computer system 501 may communicate with at least one peripheral device, 541, via an input/output (I/O) interface, 540. Such devices may include a keyboard, a pointing device, a display, etc.; at least one device that enables a user to interact with computer system 501; and/or any devices (e.g., network card, modem, etc.) that enable computer system 501 to communicate with at least one other computing devices. Such communication can occur via I/O interface 540. As depicted, I/O interface 540 communicates with the other components of computer system 501 via bus 530.

Network adapter 550 enables the computer system 501 to connect and communicate with at least one network 560, such as a local area network (LAN), a wide area network (WAN), and/or a public network (e.g., the Internet). It bridges the computer's internal bus 530 and the external network, exchanging data efficiently and reliably. The network adapter 550 may include hardware, such as modems or Wi-Fi signal transceivers, and software for packetizing and/or de-packetizing data for communication network transmission. Network adapter 550 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 560 is any computer network that can receive and/or transmit data. Network 560 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 560 may be replaced and/or supplemented by LANs designed to communicate data between devices in a local area, such as a Wi-Fi network. The network 560 typically includes computer hardware such as copper transmission cables, optical transmission fibers, wireless transmission, routers, firewalls, switches, gateway computers, edge servers, and network infrastructure known now or to be developed in the future. Computer system 501 connects to network 560 via network adapter 550 and bus 530.

User devices 561 are any computer systems used and controlled by an end user in connection with computer system 501. For example, in a hypothetical case where computer system 501 is designed to provide a recommendation to an end user, this recommendation may typically be communicated from network adapter 550 of computer system 501 through network 560 to a user device 561, allowing user device 561 to display, or otherwise present, the recommendation to an end user. User devices can be a wide array, including personal computers, laptops, tablets, hand-held, mobile phones, etc.

A public cloud 570 is an on-demand availability of computer system resources, including data storage and computing power, without direct active management by the user. Public clouds 570 are often distributed, with data centers in multiple locations for availability and performance. Computing resources on public clouds 570 are shared across multiple tenants through virtual computing environments comprising virtual machines 571, databases 572, containers 573, and other resources. A container 573 is an isolated, lightweight software for running a software application on the host operating system 521. Containers 573 are built on top of the host operating system's kernel and contain software applications and some lightweight operating system APIs and services. In contrast, virtual machine 571 is a software layer with an operating system 521 and kernel. Virtual machines 571 are built on top of a hypervisor emulation layer designed to abstract a host computer's hardware from the operating software environment. Public clouds 570 generally offers databases 572, abstracting high-level database management activities. At least one element described or depicted in FIG. 5 can perform at least one of the actions, functionalities, or features described or depicted herein.

Remote servers 580 are any computers that serve at least some data and/or functionality over a network 560, for example, WAN, a virtual private network (VPN), a private cloud, or via the Internet to computer system 501. These networks 560 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 580 can also host remote databases 581, with the database located on one remote server 580 or distributed across multiple remote servers 580. Remote databases 581 are accessible from database client applications installed locally on the remote server 580, other remote servers 580, user devices 561, or computer system 501 across a network 560. An AI/ML model described or depicted here may reside fully or partially on any of the elements described or depicted in FIG. 5.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

What is claimed is:

1. An apparatus that reduces processor and memory use of an Artificial Intelligence (AI) model comprising:
a memory; and
at least one processor, wherein the at least one processor and the memory are communicatively coupled, the at least one processor configured to:
receive input data for the AI model;
create a multi-output Gradient Boosted Tree (GBT) based on the input data;
create a decision tree with a split objective guided by at least one output of the multi-output GBT;
implement a Scalable AI (SAI) model comprising the AI model, the decision tree, and the multi-output GBT;
reduce memory use of the SAI by at least one of:
the memory, held by the SAI, being deallocated when no longer used;
the input data being loaded in shared memory to share between worker-processes of the SAI; and
arrays, in the memory, being stored as memory mapped files; and
reduce processor cycles use of the SAI, by the at least one processor, by at least one of:
computations being performed in 32-bit floating-point resolution;
computations being performed in 64-bit floating-point resolution;
computations being performed in a same floating-point resolution for all calculations; or
computations being performed as vector floating-point operations on at least one of Graphical Processing Units (GPUs), Tensor Processing Units (TPUs), Neural Processing Units (NPUs), Artificial Intelligence Processors (AIPs), or Central Processing Units (CPUs).

2. The apparatus of claim 1, wherein the at least one processor is configured to perform at least one of:
scale the input data to a defined range; or
scale the input data with a min-max scaler.

3. The apparatus of claim 1, wherein the at least one processor is configured to scale the input data with a class-conditional scaler.

4. The apparatus of claim 1, wherein the at least one processor is configured to:
implement a trained SAI model; and
generate synthetic data by the trained SAI model.

5. The apparatus of claim 1, wherein the at least one processor is configured to:
implement a trained SAI model;
generate data by the trained SAI model that is statistically similar to the input data; and
use the generated data to augment the input data or to replace the input data.

6. The apparatus of claim 1, wherein the at least one processor is configured to:
implement a trained SAI model; and
adjust processor and memory use by at least one of:
utilization of multiple worker-processes; or
store the input data in the memory shared between the worker-processes.

7. The apparatus of claim 1, wherein the at least one processor is configured to:
implement a trained SAI model;
receive additional input data; and
generate synthetic data based on the additional input data by the trained SAI model.

8. A method that reduces processor and memory use of an Artificial Intelligence (AI) model comprising:
loading an Artificial Intelligence (AI) model from a storage;
receiving input data for the AI model;
creating a multi-output Gradient Boosted Tree (GBT) based on the input data;
creating a decision tree with a split objective guided by at least one output of the multi-output GBT;
creating a Scalable AI (SAI) model comprising the AI model, the decision tree, and the multi-output GBT;
reducing memory use of the SAI by at least one of:
deallocating memory held by the SAI when no longer used;
loading input data in shared memory for sharing between worker-processes of the AI model; or
storing arrays in memory as memory mapped files; and
reducing processor cycles use of the SAI by performing computations by at least one of:
using 32-bit floating-point resolution;
using 64-bit floating-point resolution;
using a same floating-point resolution for all calculations; or
using vector floating-point operations on at least one of Graphical Processing Units (GPUs), Tensor Processing Units (TPUs), Neural Processing Units (NPUs), Artificial Intelligence Processors (AIPs), or Central Processing Units (CPUs).

9. The method of claim 8 comprising at least one of:
scaling the input data to a defined range; or
scaling the input data using a min-max scaler.

10. The method of claim 8 comprising scaling the input data using a class-conditional scaler.

11. The method of claim 8 comprising:
implementing a trained SAI model; and
generating synthetic data by the trained SAI model.

12. The method of claim 8 comprising:
implementing a trained SAI model;
generating data by the trained SAI model that is statistically similar to the input data; and
using the generated data to augment the input data or to replace the input data.

13. The method of claim 8 comprising:
implementing a trained SAI model; and
adjusting processor and memory use by at least one of:
using multiple worker-processes; or
storing the input data in the memory shared between the worker-processes.

14. The method of claim 8 comprising:
implementing a trained SAI model;
receiving additional input data; and
generating synthetic data based on the additional input data by the trained SAI model.

15. A non-transitory computer-readable storage medium comprising instructions for reducing computer processor and memory use of an Artificial Intelligence model, that when read by a processor, cause the processor to perform:
loading an Artificial Intelligence (AI) model from a storage;
receiving input data for the AI model;
creating a multi-output Gradient Boosted Tree (GBT) based on the input data;
creating a decision tree with a split objective guided by at least one output of the multi-output GBT;
creating a Scalable AI (SAI) model comprising the AI model, the decision tree, and the multi-output GBT;
reducing memory use of the SAI by at least one of:
deallocating memory held by the SAI when no longer used;
loading input data in shared memory for sharing between worker-processes of the AI model; and
storing arrays in memory as memory mapped files;
and
reducing processor cycles use by performing computations by at least one of:
using 32-bit floating-point resolution;
using 64-bit floating-point resolution;
using a same floating-point resolution for all calculations; or
using vector floating-point operations on at least one of Graphical Processing Units (GPUs), Tensor Processing Units (TPUs), Neural Processing Units (NPUs), Artificial Intelligence Processors (AIPs), or Central Processing Units (CPUs).

16. The non-transitory computer-readable storage medium of claim 15, wherein the processor is configured to perform at least one of:
scaling the input data to a defined range;
scaling the input data using a min-max scaler; or
comprising scaling the input data using a class-conditional scaler.

17. The non-transitory computer-readable storage medium of claim 15, wherein the processor is configured to perform:
implementing a trained SAI model; and
generating synthetic data by the trained SAI model.

18. The non-transitory computer-readable storage medium of claim 15, wherein the processor is configured to perform:
implementing a trained SAI model;
generating data by the trained SAI model that is statistically similar to the input data; and
using the generated data to augment the input data or to replace the input data.

19. The non-transitory computer-readable storage medium of claim 15, wherein the processor is configured to perform:
implementing a trained SAI model; and
adjusting processor and memory use by at least one of:
using multiple worker-processes; or
storing the input data in the memory shared between the worker-processes.

20. The non-transitory computer-readable storage medium of claim 15, wherein the processor is configured to perform:
implementing a trained SAI model;
receiving additional input data; and
generating synthetic data based on the additional input data by the trained SAI model.
